(19) United States
(12) Patent Application Publication
(10) Pub. No.: US 2025/0062499 A1
(43) Pub. Date: Feb. 20, 2025

(54) BATTERY MODULE

(71) Applicant: APB CORPORATION, Fukui (JP)

(72) Inventors: Hideaki HORIE, Fukui (JP); Yohji KAWASAKI, Kyoto (JP); Yusuke MIZUNO, Kyoto (JP)

(21) Appl. No.: 18/723,838

(22) PCT Filed: Dec. 24, 2022
(86) PCT No.: PCT/JP2022/047794

§ 371 Date: Jun. 24, 2024

(30) Foreign Application Priority Data
Dec. 24, 2021 (JP) 2021-210100

(51) Int. Cl. H01M 50/51; H01M 10/0525; H01M 10/0587; H01M 50/209; H01M 50/503; H01M 50/519; H01M 50/538; H01M 50/569

(52) U.S. Cl. CPC H01M 50/51; H01M 10/0525; H01M 10/0587; H01M 50/209; H01M 50/503; H01M 50/519; H01M 50/538; H01M 50/569

(57) ABSTRACT

A battery module includes a cell having a cathode resin current collector, a cathode active material layer, a separator, an anode active material layer, and an anode resin current collector. The cell includes a frame sealing the cathode active material layer, the separator, and the anode active material layer. The cathode resin current collector and the anode resin current collector are respectively on first and second surfaces of the cell. An assembled battery in which a number of adjacent pairs of the cells are stacked in series such that the first surface and the second surface of the adjacent pair of the cells are adjacent to each other, or an assembled battery in which a number of cells, each of which has a cathode layer and an anode layer respectively provided on different surfaces of the resin current collector, are stacked via an electrolyte layer.

### RELATED APPLICATIONS

The present application is a National Phase of International Application No. PCT/JP2022/047794 filed Dec. 24, 2022, which claims priority to Japanese Application No. 2021-210100, filed Dec. 24, 2021.

### FIELD OF THE INVENTION

This invention relates to a lithium-ion battery module and a battery pack that combines multiple battery modules.

### BACKGROUND ART

Assembled batteries, in which a plurality of unit cells made of lithium-ion batteries are stacked, have been used as a power source for electric vehicles, hybrid electric vehicles, etc., and as a power source for portable electronic devices (for example, refer to Patent Reference 1). Further, when the assembled battery is used as a stationary battery, which can be applied to an uninterruptible power supply, a power storage system, or the like, a plurality of assembled batteries are further connected in series or parallel. In a case when connecting a large number of assembled batteries, a structure that satisfies not only ease of connection and mass production but also safe and efficient use is required (for example, refer to Patent References 2, 3).

### CITATION LIST

### Patent Literature

[Patent Reference 1] WO2009/119075
[Patent Reference 2] Japanese Unexamined Patent Application Publication No. 2003-288883
[Patent Reference 3] WO2015/140952

### BRIEF SUMMARY OF THE INVENTION

### Problems that Invention is to Solve

As a method of connecting a large number of lithium-ion battery modules including assembled batteries, connecting the cathode and the anode of adjacent lithium-ion battery modules directly in series and connecting electrodes with the same pole by bus bars in parallel are common. The pseudo-equivalent circuit of a lithium-ion battery module is represented by a CR circuit representing the electrochemical reaction within the battery and an inductor component representing the inductivity of the leads and cells.

Such as in a stationary battery system, in a case when charging and discharging at a large current capacity, the influence of the inductor component due to the sudden change in current cannot be ignored. As a result, there was a problem in that the stability of the battery system was compromised.

The objective of the present invention is to provide a battery module and a battery pack with a reduced inductor component.

### Means to Solve the Problems

A battery module according to one embodiment of this invention comprises a cell that has a cathode resin current collector, a cathode active material layer, a separator, an anode active material layer, and an anode resin current collector, wherein the cell comprises a frame member that seals the cathode active material layer, the separator, and the anode active material layer, wherein the cathode resin current collector is placed on a first surface of the cell, wherein the anode resin current collector is placed on a second surface of the cell, a first assembled battery in which a predetermined number of adjacent pairs of the cells are stacked in series such that the first surface and the second surface of the adjacent pair of the cell are adjacent to each other, or a first assembled battery in which a predetermined number of cells, each of which has a cathode layer provided on one surface of a resin current collector and an anode layer provided on the other surface of the resin current collector, are stacked via an electrolyte layer; in a case when the inductance of the cell is Ia, the inductance of a wound-type cell consisting of a wound electrode group having a cathode plate that comprises a cathode metal current collector and a cathode mixture layer disposed on both sides of the cathode metal current collector, an anode plate that comprises an anode metal current collector and an anode mixture layer disposed on both sides of the anode metal current collector, and a separator that is disposed between the cathode plate and the anode plate, is Ib, the inductance of the first assembled battery is Ic, and the inductance of a first wound-type cell module formed by connecting the predetermined number of the wound-type cells in series is Id, wherein Ic/Ia<Id/Ib.

### Effects of the Invention

According to this invention, the inductor component can be reduced by a plurality of lithium-ion battery modules, including an assembled battery in which an anode current collector and a cathode current collector are directly connected, and by a battery pack in which battery modules are connected in series.

### BRIEF DESCRIPTION OF DRAWINGS

FIG. 1 is a partially cutaway perspective view schematically showing an example of a cell unit.

FIG. 2 is a perspective view schematically showing an example of a light-emitting part.

FIG. 3 is a partially cutaway perspective view schematically showing an example of a lithium-ion battery module.

FIG. 4 is a function block view of a battery system including a lithium-ion battery module.

FIG. 5A and FIG. 5B are views showing the structure of the battery pack rack.

FIG. 6 is a view of a first example of a connection configuration of lithium-ion battery modules in a battery slot.

FIG. 7 is a view of a second example of a connection configuration of lithium-ion battery modules in a battery slot.

FIG. 8 is a view of a third example of a connection configuration of lithium-ion battery modules in a battery slot.

FIG. 9 is a view of the configuration of the lead wire of the lithium-ion battery module.

### DESCRIPTION OF EMBODIMENTS

Hereinafter, this variation will be described in detail. In the present specification, the lithium-ion battery shall include a concept of a lithium-ion secondary battery as well.

### Cell Unit

An assembled battery is made up of multiple cell units connected to each other, and each battery unit is equipped with a cell and a light-emitting part. The cell units are preferably connected in series within the assembled battery. First, a cell unit comprising a cell and a light-emitting part will be described.

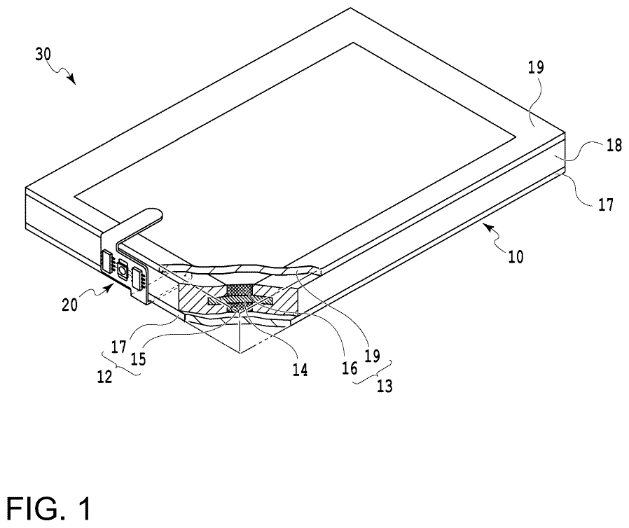

FIG. 1 is a partially cutaway perspective view schematically showing an example of the cell unit. FIG. 1 shows a cell unit 30 comprising a cell 10, which is a lithium-ion battery, and a light-emitting part 20. The cell 10 is formed into a substantially-rectangular and planar shape as a whole by stacking a cathode 12, which is obtained by forming a cathode active material layer 15 on the surface of a substantially-rectangular and planar cathode current collector 17, and an anode 13, which is obtained by forming an anode active material layer 16 on the surface of a similarly substantially-rectangular and planar anode current collector 19, via a similarly substantially-planar separator 14. This cathode and the anode function as a cathode and an anode of the lithium-ion battery.

The cell 10 has an annular frame member 18 disposed between the cathode current collector 17 and the anode current collector 19 to fix the edge portion of the separator 14 between the cathode current collector 17 and the anode current collector 19 and seal the cathode active material layer 15, the separator 14, and the anode active material layer 16.

The cathode current collector 17 and the anode current collector 19 are positioned by the frame member 18 so as to be opposed at a predetermined interval. The separator 14, the cathode active material layer 15, and the anode active material layer 16 are also positioned by the frame member 18 so as to be opposed at a predetermined interval.

An interval between the cathode current collector 17 and the separator 14 and an interval between the anode current collector 19 and the separator 14 are adjusted according to the capacity of the lithium-ion battery. The positional relationship among the cathode current collector 17, the anode current collector 19, and the separator 14 is determined so as to obtain necessary intervals.

A preferred aspect of each constituent element of the cell will be hereinafter described. The cathode active material layer includes a cathode active material. Examples of the cathode active material include a composite oxide of lithium and a transition metal {a composite oxido having one kind of transition metal (LiCoO₂, LiNiO₂, LiAlMnO₄, LiMnO₂, LiMn₂C₄, or the like), a composite oxide having two kinds of transition metal elements (for example, LiFeMnO4, LiNi₁₋ₓCoₓO₂, LiMn_{1-y}Co_{y}O₂, LiNi_{1/3}CoO_{1/3}Al_{1/3}O₂, and LiNi_{0.8}Co_{0.15}Al_{0.05}O₂), a composite oxide having three or more kinds of metal elements [for example, LiMₐM′_{b}M″_{c}O₂ (where M, M′, and M″ are transition metal elements different each other and satisfy a+b+c=1, and one example is LiNi_{1/3}Mn_{1/3}Co_{1/3}O₂)], or the like}, a lithium-containing transition metal phosphate (for example, LiFePO₄, LiCoPO₄, LiMnPO₄, or LiNiPO₄), a transition metal oxide (for example, MnO₂ and V₂O₅), a transition metal sulfide (for example, MoS₂ or TiS₂), and a conductive macromolecule (for example, polyaniline, polypyrrole, polythiophene, polyacetylene, poly-p-phenylene, or polyvinyl carbazole). Two or more thereof may be used in combination. Here, the lithium-containing transition metal phosphate may be one in which a part of transition metal sites is substituted with another transition metal.

The cathode active material is preferably a coated cathode active material coated with a conductive agent and a coating resin. If the exterior of the cathode active material is coated with a coating resin, a change in volume of an electrode is reduced and the expansion of the electrode can be suppressed.

Examples of the conductive agent include metal-based conductive agents (aluminum, stainless steel [SUS], silver, gold, copper, titanium, etc.), carbon-based conductive agents (graphite and carbon black [acetylene black, ketjen black, furnace black, channel black, thermal lamp black, etc.] etc.), and mixtures thereof. Among these conductive agents, a single kind may be used alone and two or more kinds may be used together. Further, they may be used as their alloys or metal oxides. In particular, from the viewpoint of electrical stability, aluminum, stainless steel, silver, gold, copper, titanium, carbon-based conductive agents and mixtures thereof are more preferable, silver, gold, aluminum, stainless steel and carbon-based conductive agents are yet more preferable, and carbon-based conductive agents are especially preferable. These conductive agents may be ones obtained by coating the periphery of a particulate ceramic material or resin material with a conductive material (preferably metal-based ones among the conductive agents listed above) by means of plating or the like.

The shape (form) of the conductive agent is not limited to a particulate form and may be a form other than the particulate form such as a form actually used as a so-called filler conductive agent such as a carbon nanofiber or carbon nanotube.

The ratio between the coating resin and the conductive agent is not particularly limited. However, from the viewpoint of the internal resistance of the battery and the like, the weight ratio between the coating resin (weight of resin solids) and the conductive agent is preferably from 1:0.01 to 1:50, and more preferably from 1:0.2 to 1:3.0.

As the coating resin, ones disclosed as nonaqueous secondary battery active material coating resins in Patent Reference 2 can be suitably used.

Further, the cathode active material layer may include a conductive agent other than the conductive agent included in the coated cathode active material. As the conductive agent, the same ones as those included in the coated cathode active material described above can be suitably used.

It is preferable that the cathode active material layer include cathode active materials and be an unbound body not including a binding agent which binds the cathode active materials together. The unbound body used here means that the positions of cathode active materials are not fixed by a binding agent (also referred to as a binder), the cathode active materials are not fixed irreversibly to each other, and the cathode active materials and the current collector are not fixed irreversibly to each other.

The cathode active material layer may include an adhesive resin. As the adhesive resin, for example, one obtained by mixing a small amount of organic solvent with a nonaqueous secondary battery active material coating resin disclosed in Patent Reference 2 and adjusting its glass transition temperature below the room temperature and one disclosed as an adhesive in Patent Reference 3 can be suitably used. The adhesive resin means a resin which does not solidify and has adhesion (the property of adhering by applying a slight pressure without the use of water, solvent, or heat) even if solvent components are volatilized and dried. In contrast, an electrode binder of a solvent drying type used as the binding agent indicates one drying and solidifying by volatilizing solvent components to strongly bond and fix active materials. Accordingly, an electrode binder (binding agent) of a solvent drying type is a material different from the adhesive resin.

The thickness of the cathode active material layer is not particularly limited. However, from the viewpoint of battery performance, the thickness is preferably from 150 to 600 μm and more preferably from 200 to 450 μm.

The anode active material layer includes an anode active material. As the anode active material, a well-known anode active material for a lithium-ion battery can be used and examples thereof include carbon-based materials (graphite, non-graphitizable carbon, amorphous carbon, resin calcined material [e.g., calcined and carbonized phenolic resin and furan resin], cokes [e.g., pitch coke, needle coke, and petroleum coke], carbon fibers, etc.), silicon-based materials (silicon, silicon oxide [SiOₓ], silicon-carbon composites [carbon particles with surfaces coated with silicon and/or silicon carbide, silicon particles or silicon oxide particles with surfaces coated with carbon and/or silicon carbide, silicon carbide, etc.], silicon alloys [silicon-aluminum alloy, silicon-lithium alloy, silicon-nickel alloy, silicon-iron alloy, silicon-titanium alloy, silicon-manganese alloy, silicon-copper alloy, silicon-tin alloy, etc.] etc.), conductive polymers (e.g., polyacetylene and polypyrrole), metals (tin, aluminum, zirconium, titanium, etc.), metal oxides (titanium oxide, lithium-titanium oxide, etc.), metal alloys (e.g., lithium-tin alloy, lithium-aluminum alloy, and lithium-aluminum-manganese alloy), and mixtures of them and carbon-based materials.

Further, the anode active material may be a coated anode active material coated with a conductive agent and a coating resin like the coated cathode active material described above. As the conductive agent and the coating resin, the same conductive agent and coating resin as those used for the coated cathode active material described above can be suitably used.

Further, the anode active material layer may include a conductive agent other than the conductive agent included in the coated anode active material. As the conductive agent, the same conductive agent as that included in the coated cathode active material described above can be suitably used.

The anode active material layer is preferably an unbound body not including a binding agent which binds anode active materials together like the cathode active material layer. Further, the anode active material layer may include an adhesive resin like the cathode active material layer.

The thickness of the anode active material layer is not particularly limited. However, from the viewpoint of battery performance, the thickness is preferably from 150 to 600 μm and more preferably from 200 to 450 μm.

Examples of the material for the cathode current collector and the anode current collector (hereinafter collectively referred to as current collectors) include metal materials such as copper, aluminum, titanium, stainless steel, nickel, and alloys thereof, calcined carbon, conductive polymeric material, and conductive glass. Among these materials, from the viewpoint of weight reduction, corrosion resistance, and high conductivity, it is preferable to use aluminum as the cathode current collector and copper as the anode current collector.

Further, the current collectors are preferably resin current collectors made of a conductive polymeric material. The shape of the current collector is not particularly limited and may be a sheet-like current collector made of the material stated above or a deposited layer made from fine particles of the material stated above. The thickness of the current collector is not particularly limited but is preferably from 50 to 500 μm.

As the conductive polymeric material for the resin current collector, for example, a conductive polymeric material or resin to which a conductive agent is added as necessary can be used. As the conductive agent for the conductive polymeric material, the same conductive agent as that included in the coated cathode active material described above can be suitably used.

Examples of the resin forming the conductive polymeric material include polyethylene (PE), polypropylene (PP), polymethylpentene (PMP), polycycloolefin (PCO), polyethylene terephthalate (PET), polyether nitrile (PEN), polytetrafluoroethylene (PTFE), styrene-butadiene rubber (SBR), polyacrylonitrile (PAN), polymethylacrylate (PMA), polymethylmethacrylate (PMMA), polyvinylidene fluoride (PVdF), epoxy resin, silicone resin, and a mixture thereof. From the viewpoint of electrical stability, polyethylene (PE), polypropylene (PP), polymethylpentene (PMP), and polycycloolefin (PCO) are preferable, and polyethylene (PE), polypropylene (PP), and polymethylpentene (PMP) are more preferable.

Examples of the separator include a well-known separator for a lithium-ion battery such as a porous film made of polyethylene or polypropylene, a laminated film of a porous polyethylene film and a porous polypropylene film, a nonwoven fabric made of synthetic fibers (polyester fibers, aramid fibers, etc.), glass fibers, etc., and those having a surface with fine ceramic particles of silica, alumina, titania, etc. adhering thereto. Furthermore, a sulfide-based or oxide-based inorganic solid electrolyte or a polymer-based organic solid electrolyte can be used as the separator. By applying the solid electrolyte, an all-solid battery can be constituted.

The cathode active material layer and the anode active material layer include an electrolyte solution. As the electrolyte solution, a well-known electrolyte solution for use in manufacture of a well-known lithium-ion battery containing an electrolyte and a nonaqueous solvent can be used.

As the electrolyte, one used for a well-known electrolyte solution or the like can be used and examples thereof include inorganic acid lithium salts such as LiN(FSO₂)₂, LiPF₆, LiBF₄, LiSbF₆, LiAsF₆, and LiClO₄ and organic acid lithium salts such as LiN(CF₃SO₂)₂, LiN(C₂F₅SO₂)₂, and LiC(CF₃SO₂)₃. Among them, from the viewpoint of battery output and charge/discharge cycle characteristics, it is preferable to use imide-based electrolytes (LiN(FSO₂)₂, LiN(CF₃SO₂)₂, LiN(C₂F₅SO₂)₂, etc.) and LiPF₆.

As the nonaqueous solvent, one used for a well-known electrolyte solution or the like can be used. For example, a lactone compound, cyclic or chain carbonate ester, chain carboxylic acid ester, cyclic or chain ether, phosphoric ester, nitrile compound, amide compound, sulfone, sulfolane, and mixtures thereof can be used.

The electrolyte concentration of the electrolyte solution is preferably from 1 to 5 mol/L, more preferably from 1.5 to 4 mol/L, and yet more preferably from 2 to 3 mol/L. If the electrolyte concentration of the electrolyte solution is less than 1 mol/L, sufficient input/output characteristics of the battery cannot be obtained in some cases. If the electrolyte concentration of the electrolyte solution exceeds 5 mol/L, the electrolyte is often precipitated. The electrolyte concentration of the electrolyte solution can be checked by extracting an electrolyte solution forming an electrode for a lithium ion battery or a lithium ion battery without using a solvent or the like and measuring its concentration.

As mentioned above, the assembled battery is made up of multiple cell units. For example, a predetermined number of assembled batteries are stacked in series so as to arrange the cathode resin current collector and the anode resin current collector of each pair of adjacent cell units that are adjacent to each other. Furthermore, a plurality of unit cells may be stacked with an electrolyte layer interposed therebetween to form an assembled battery, wherein the unit cell has a cathode layer placed on one surface of a resin current collector and an anode layer placed on the other surface of the resin current collector.

### [Light-Emitting Part]

Conventionally, in terms of monitoring the terminal voltage of each cell, the cell and a measuring element were electrically connected by metal wiring, and the measuring element was also electrically connected to a monitoring and controlling device. If each of the cells is electrically connected with wiring, there is a risk of a short circuit between the cells. In addition, there was a problem that the wiring became complicated.

In order to solve such problems, the inventors of the present invention have discovered a configuration that does not use electrical wiring. Specifically, in the configuration, each of the cells included in the assembled battery is equipped with a light-emitting part that measures the characteristics of the cell and outputs an optical signal based on the characteristics, and a light-receiving part that collectively receives the optical signals output from each light-emitting part. With this configuration found by the inventors, it is possible to avoid the risk of short-circuiting between the cells by analyzing the optical signal received by the light-receiving part (for example, by analyzing it with a data processing unit connected to the light-receiving part), wherein the short-circuiting occurs when wiring is connected to each cell as in the conventional method. In addition, the wiring steps are reduced, and the manufacturing costs of the assembled battery can be reduced.

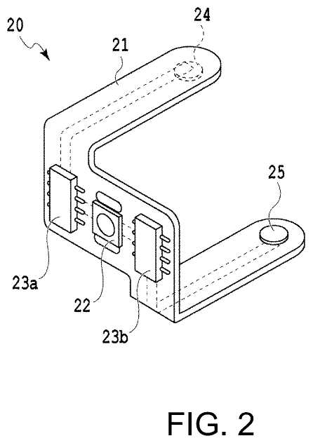

FIG. 2 is a perspective view schematically showing an example of the light-emitting part. The light-emitting part 20 shown in FIG. 2 comprises a wiring board 21 having wiring therein or on its surface and a light-emitting element 22 and control elements 23a and 23b mounted on the wiring board 21. The ends of the wiring board are provided with measuring terminals 24 and 25. The measuring terminals 24 and 25 are provided at such positions that in a case where they are connected to a cell, one measuring terminal is in contact with the cathode current collector and the other measuring terminal is in contact with the anode current collector. In this case, the measuring terminals 24 and 25 function as voltage measuring terminals which measure a voltage between the cathode current collector and the anode current collector of the cell.

The measuring terminals 24 and 25 are electrically connected to the control elements 23a and 23b and the control elements 23a and 23b are electrically connected to the light-emitting element 22. The light emission of the light-emitting part 20 is controlled so that the amount of power consumption changes according to the voltage of the cell.

Further, a measuring terminal (not shown) is also provided on a surface of the wiring board 21 on the back of the light-emitting element 22. This measuring terminal can be used as a temperature measuring terminal by connecting it to a temperature sensor for measuring the temperature of the cell. Also, this measuring terminal can be connected to a strain gauge, a piezoelectric element, or the like and used as a terminal for measuring physical changes in the cell. The measuring terminals is also electrically connected to the control elements 23a and 23b and the control elements 23a and 23b are electrically connected to the light-emitting element 22. For example, the light emission of the light-emitting part 20 is controlled so that the amount of power consumption changes according to the temperature of the cell.

The wiring board constituting the light-emitting part may be a rigid board or a flexible board. When the wiring board has a shape as shown in FIG. 2, it is preferable to use a flexible board. As the control element, any semiconductor element such as an IC or an LSI can be used. Although FIG. 2 shows an example in which two control elements are implemented, the number of control elements is not limited, and may be one, or three or more. As the light-emitting element, an element capable of converting an electrical signal into an optical signal, such as an LED element or an organic EL element, can be used, and an LED element is preferable. It is not essential that the light-emitting part has a wiring board, and the light-emitting part may be configured by wiring the control element and the light-emitting element without using a board.

The light-emitting part is electrically connected to the anode current collector and the cathode current collector of the cell, and is capable of receiving power from the lithium-ion battery. When the light-emitting part is electrically connected to the anode current collector and the cathode current collector, the light-emitting element can emit light by receiving power supply from the lithium-ion battery. Although the electrodes for receiving power supply are not shown in FIG. 2, it is preferable to provide electrodes, which is different from the voltage measuring terminals, to the light-emitting part.

The anode current collector and the cathode current collector are preferably resin current collectors, and the anode current collector and the cathode current collector are preferably directly bonded to the electrodes of the light-emitting part electrically. When a resin current collector is used, the resin current collector and the electrode of the light-emitting part can be directly bonded to each other by contacting the resin current collector with the electrode of the light-emitting part, and by heating the resin current collector and softening the resin. In addition, electrical connection can also be achieved by interposing other conductive bonding materials, such as solder, conductive tape, conductive adhesive, and anisotropic conductive film (ACF), between the current collector and the light-emitting part.

### [Lithium-Ion Battery Module]

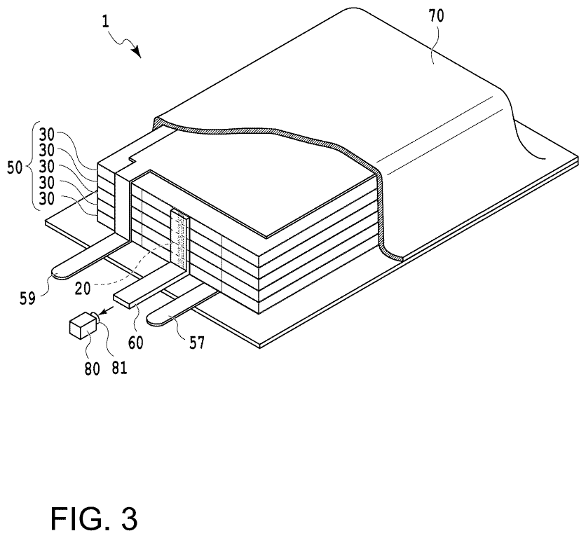

FIG. 3 is a partially cutaway perspective view schematically showing an example of the lithium-ion battery module. The lithium-ion battery module 1 comprises an assembled battery 50, which is formed by connecting a plurality of cell units 30. In the assembled battery 50, the cells 10 are stacked such that the upper surface of the anode current collector 19 and the lower surface of the cathode current collector 17 of adjacent cells 10 are adjacent to each other. A plurality of so-called bipolar type cell units 30 are connected in series. FIG. 3 shows a configuration in which five cell units 30 are stacked, but the number of stacked cells may be more or less than five. In one embodiment, the number of stacked cell units 30 may be 20 or more.

The light-emitting parts 20 of the respective cell units 30 are arranged in a row on the outer surface (side surface) of the assembled battery 50. Although FIG. 3 shows a configuration in which the light-emitting parts 20 are arranged in a row, the positional relationship of the light-emitting parts between different cell units is not limited thereto. The light-emitting parts may be provided on different side surfaces of the cell unit, or may be positioned offset from one another on the same side surface.

Furthermore, the lithium-ion battery module 1 has an optical waveguide 60 disposed adjacent to or in close proximity to the light-emitting surface of the light-emitting part 20.

The lithium-ion battery module 1 has an exterior body 70 that accommodates a plurality of unit cells 30 and the optical waveguide 60. In FIG. 3, a part of the exterior body is removed in order to explain the configuration of the assembled battery. The exterior body may be a metal can case, a polymer-metal composite film, or the like.

A conductive sheet is provided on the anode current collector 19, which is the uppermost surface of the assembled battery 50. A part of the conductive sheet is pulled out from the exterior body 70 to serve as a lead wire 59. Further, a conductive sheet is provided below the cathode current collector 17, which is the bottom surface of the assembled battery 50. A portion of the conductive sheet is pulled out from the exterior body 70 to serve as a lead wire 57. The conductive sheet is not particularly limited as long as it is made of a conductive material. Examples of materials forming the conductive sheet include metal materials such as copper, aluminum, titanium, stainless steel, nickel, and their alloys, as well as materials listed as resin current collectors. The lead wire can be used to charge and discharge the assembled battery.

The optical waveguide 60 provides a common optical path for optical signals emitted from the light-emitting part 20 of the multiple cell units 30. As shown in FIG. 3, the optical waveguide 60 extended along the stacking direction of the cells 30 is arranged adjacent to or close to the light-emitting surface of the light-emitting part 20. The optical waveguide 60 may be a light guide plate having a width (length in a direction perpendicular to the stacking direction of the unit cells) sufficient to receive the optical signal from the light-emitting part 20. In a case when the optical waveguide 60 is formed of a light guide plate, the widthwise dimension of the optical waveguide 60 is preferably larger than the maximum dimensions (Diameter if the light emitting surface and the light receiving surface are circular; diagonal if rectangular) of the light-emitting surface of the light-emitting part 20.

In a case when using a light guide plate as the optical waveguide 60, the optical waveguide 60 is arranged so as to cover all of the light-emitting surfaces of the plurality of light-emitting parts 20 (each corresponding to a plurality of stacked cells). Further, the optical waveguide 60 can be arranged so as to cover the light-emitting direction of the light-emitting part 20 (including a case where the light-emitting surface coincides with the vertical direction and a case where the light-emitting surface is inclined from the vertical direction).

In order to increase the coupling efficiency of optical signals from the light-emitting part 20 to the light guide plate as the optical waveguide 60, additional parts such as lenses may be used. A light guide plate subjected to light condensing processing may also be used. Furthermore, it is also possible to use the optical waveguide 60 extended along the direction perpendicular to the stacking direction of the cells. In this case, the light guide plate serving as the optical waveguide 60 can cover all of the light-emitting surfaces of the plurality of light-emitting parts 20. By forming it in a tapered shape toward the optical output part, the optical signal output from the tapered optical output part can be received by the light-receiving part 80.

The optical waveguide 60 may be an optical fiber, for example, a tape-type fiber in which a plurality of core wires are bundled. In addition, when the light-receiving part 80 is arranged inside the exterior body 70, a space may be provided between the light-emitting direction of the light-emitting part 20 and the inner surface of the exterior body 70, and a spatial optical system may be constructed between the light-receiving part 80. In this case, in order to increase the coupling efficiency of the optical signal from the light-emitting part 20, an additional component such as a reflector may be used inside the exterior body 70, or the inner surface of the exterior body 70 may be processed as a reflective surface.

The light emitted from the light-emitting part 20 is optically coupled with the optical waveguide 60 and exits from the optical output part, wherein the light-emitting part 20 is provided in each of the 20 or more cells 30 arranged adjacent to or close to one optical waveguide 60. In this embodiment, a part of the optical waveguide 60 is drawn out from the exterior body 70 and serves as a light output part, where the optical signal incident and propagated from each light-emitting part 20 is output. The optical signal emitted from the optical input/output part is received by the light-receiving part 80.

The optical signal output from one end of the optical waveguide outside the exterior body is received by the light-receiving part 80. The light-receiving part 80 comprises a light-receiving element 81. By converting the optical signal back into an electrical signal by the light-receiving element 81, an electrical signal indicating the internal state of the cell unit 30 included in the assembled battery 50 can be obtained. The light-receiving element 81 may be a photodiode, a phototransistor, or the like, and is preferably a photodiode. The light-receiving part 80 may be configured by using an LED element, which is a light-emitting element, as a light-receiving element.

When the entire optical waveguide 60 including a light output part is housed inside the exterior body 70, the optical signal output from the optical output part is received by the light-receiving part 80 placed inside the exterior body 70.

The light-receiving part 80, which is disposed apart from the assembled battery, is not electrically connected to the optical waveguide 60, and information is transmitted between the light-receiving part 80 and the optical waveguide 60 by optical signals. In other words, the light-receiving part 80 and the assembled battery 50 are electrically insulated.

The exterior body 70 houses the assembled battery 50 and at least a portion of the optical waveguide 60 and the lead wires 57, 59. The exterior body 70 can be constructed using a metal can case or a polymer-metal composite film. The exterior body 70 is sealed to maintain a reduced pressure inside.

The control elements 23a, 23b of the light-emitting part 20 are configured to function as a measurement circuit that measures the characteristics of the corresponding cells 10 and generates a characteristic signal representing the measured characteristic. For example, a binary signal corresponding to the voltage input to the voltage measuring terminals 24, 25 is generated as the characteristic signal. The characteristic signal can be generated by converting the voltage input to the voltage measuring terminal into a binary signal while using a look-up table that defines a voltage range and a corresponding signal pattern. Alternatively, the voltage input to the voltage measuring terminal may be converted into an 8-bit (or 16-bit) binary signal by analog/digital conversion.

Similarly, the measurement circuits of the control elements 23a and 23b can convert the output of a temperature sensor connected to the measuring terminals described above into a binary signal and can convert the output of a strain gauge, a piezoelectric element, etc. into a binary signal.

The control elements 23a, 23b are configured to function as a control circuit that outputs a control signal obtained by encoding a characteristic signal at every predetermined period. The control signal coded into a predetermined pattern is supplied to the light-emitting part 20, and an optical signal corresponding to the control signal is output to the optical waveguide 60. In addition, the control elements 23a, 23b encode a unique identifier and add it to the control signal, and output it to the corresponding cell unit 30 together with the characteristic signal. Since an optical signal is output based on a control signal, in which an identifier is encoded, together with a characteristic signal of the corresponding cell unit 30, it is possible to identify which cell the status information pertains to by the receiving side.

Since the lithium-ion battery module 1 of this embodiment comprises the assembled battery 50 in which the anode current collector 19 and the cathode current collector 17 of a pair of cells are directly connected, the inductor components caused by the leads and cells can be significantly reduced. The inductor component of the assembled battery 50 is dominated by the inductor component of the conductive sheets that form the lead wires 57, 59. That is, the inductor component when one cell 10 is provided with the lead wires 57, 59 is approximately equal to the inductor component when a plurality of cells 10 are stacked and provided with the lead wires 57, 59. A comparative example between the lithium-ion battery module 1 of this embodiment and a conventional wound-type cell module will be described below. For example, the lithium-ion battery module 1 including the assembled battery 50 in which 40 layers of 40 cm×40 cm cells 10 are stacked has the total energy capacity of 3.0 kW. For example, when a copper material is used for a lead wire, the inductor component (Ia) of the cell 10 and the inductor component (Ic) of the lithium-ion battery module 1 including the assembled battery 50 are approximately equal at 320 nH.

The wound-type cell comprises a cathode plate having a cathode mixture layer disposed on both sides of a cathode metal current collector, an anode plate having an anode mixture layer disposed on both sides of an anode metal current collector, and a separator disposed between the cathode plate and the anode plate. While using a typical 18650 type battery as a wound-type cell, in order to obtain an output of 3.0 kW of total energy equivalent to that described above, for example, a wound-type cell module having 6 cells in parallel, each of which is made up of 40 cells connected in series, can be used. The inductor component (Ib) of one 18650 type battery is 450 nH, and when connected in series, the inductor component is multiplied by the number of connections. When compared with other stacked-type battery modules such as wound-type cell modules, the inductor component that increases with each stack, that is, the smaller the increase rate of the inductor component, the more preferable it is. In other words, if the inductor component of the wound-type cell module in which the same number of wound-type cells as the number of stacked cells 10 in the assembled battery 50 of the lithium-ion battery module 1 are connected in series is (Id), it is desirable to satisfy Ic/Ia<Id/Ib.

The inductor component (If) of the entire wound-type cell module to obtain the same output as above is 450×40/6=3000 nH. The lithium-ion battery module 1 of the present embodiment can achieve an inductor component of Ie(=Ic)/If<0.11, as compared with the conventional case. Herein, when the lithium-ion battery module 1 of this embodiment and the wound-type cell module are configured to correspond to the total energy amount of 0.5 to 3.3 kW, it is possible to satisfy Ie/If<0.11.

In addition, when the wound-type cell module is constructed using 18650-type batteries, a configuration in which the batteries are connected in parallel may also be possible. The inductance component of the tab busbar for connecting 18650-type batteries is approximately 5 nH. For example, the inductance component of the entire wound-type cell module when 240 18650-type batteries are connected in parallel, is estimated to be about 240×5 nH=1200 nH.

### [Battery System]

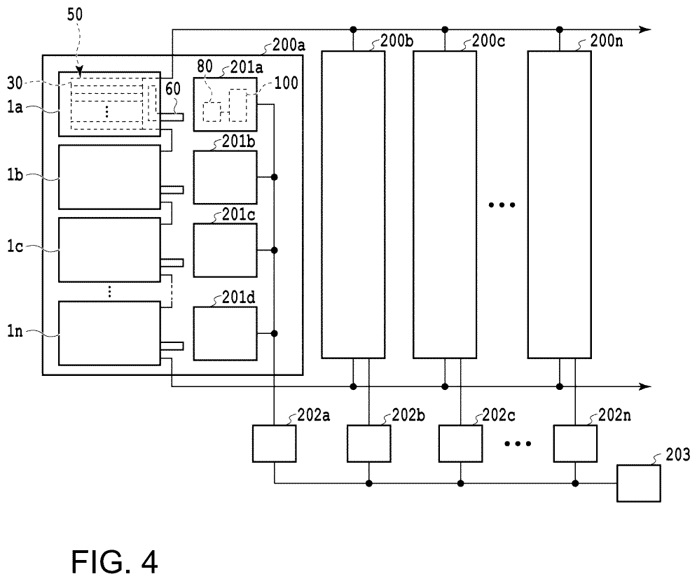

FIG. 4 shows a battery system including a lithium-ion battery module. This shows a stationary high-voltage, large-capacity battery system. A battery pack 200 is formed by connecting a plurality of lithium-ion battery modules 1a-1n in series. For example, the battery pack 200 having an output of 6600V is formed by connecting 40 lithium-ion battery modules in series, wherein each lithium-ion battery module includes the assembled battery 50 in which 48 cells 30 are stacked. The battery system capable of outputting power equivalent to that of a commercial power source is configured by connecting a plurality of battery packs 200a-200n in parallel. A variety of battery systems can be configured by arbitrarily setting the number of stacked cells, the number of connected lithium-ion battery modules, and the number of connected battery packs.

The lithium-ion battery module 1 is connected to a battery module management device 201 that includes a light-receiving part 80 and a signal processing device 100 via an optical waveguide 60. Each signal processing device 100 is connected to a battery pack management device 202 and a plurality of the battery pack management devices 202a-202n are connected to a battery system management device 203.

The battery module management device 201 comprises the light-receiving part 80 and the signal processing device 100. The light-receiving part 80 includes a light-receiving element optically connected to the optical waveguide 60, and any communication method can be applied between a plurality of the light-emitting parts 20 and the light-receiving parts 80. Since a plurality of the light-emitting parts 20 use the optical waveguide 60 as a common optical path, the light-receiving part 80 can identify from which of the light-emitting parts 20 of which cell 10 has emitted the signal. The signal processing device 100 acquires characteristic signals, etc., of each cell in the lithium-ion battery module 1 received by the light-receiving part 80, determines the state of each cell based on the acquired data, and estimates the state of each cell. The signal processing device 100 may be a general-purpose integrated circuit in which a processor, memory, and the like are integrated. The signal processing device 100 may also be a computing device including a dedicated integrated circuit in which an FPGA, an ASIC, or the like is integrated, and a computer-readable storage medium.

The battery pack management device 200 may be a general-purpose integrated circuit in which a processor, memory, and the like are integrated. The battery pack management device 202 may also be configured by an on-board computer or the like, including a dedicated integrated circuit in which an FPGA, an ASIC, or the like is integrated. The battery pack management device 202 acquires information such as the state of the lithium-ion battery module 1 via the communication circuit of the battery module management device 201. Furthermore, the battery pack management device 202 measures the output voltage of the battery pack, the current during charging and discharging, the temperature distribution of the battery pack, and the like.

The battery pack management device 202 analyzes the state of the battery pack from the acquired information and measurement results, and monitors and controls the battery pack. The battery pack management device 202 can, for example, detect and separate the lithium-ion battery module in which an abnormality has occurred based on information from the signal processing device 100, or cut off the output of the battery pack and separate it from the battery system. In addition, the measurement results and analysis results can be transmitted to the battery system management device 203, which is a higher-level management device.

The battery system management device 203 has a function equivalent to a so-called PCS (Power Conditioning Subsystem) and has functions such as DC/AC conversion, charge/discharge control, and grid interconnection functions. The battery system management device 203 is connected to a plurality of battery pack management devices 202 via communication lines. The battery system management device 203 analyzes the state of the battery pack based on the acquired information and sends commands to the battery pack management device 202 or the battery module management device 201 according to the operating status of the battery system.

### [Battery Pack Rack]

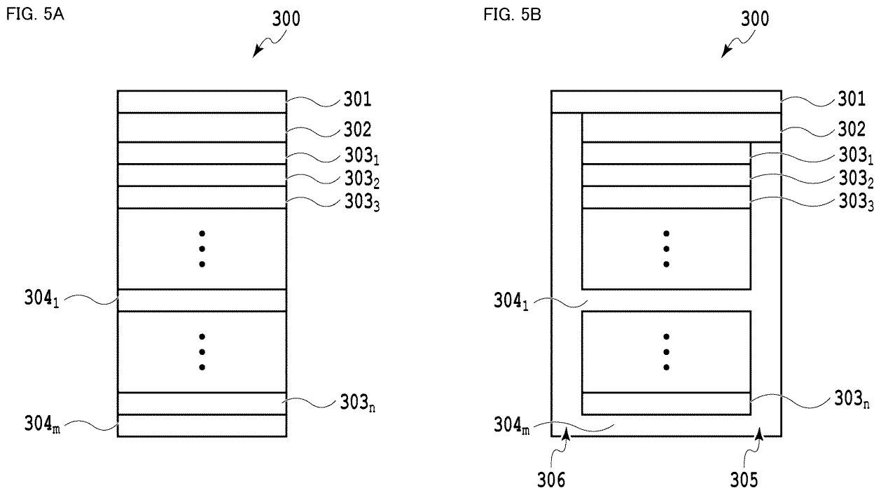

The structure of the battery pack rack is shown in FIG. 5A and FIG. 5B. FIG. 5A is a schematic diagram of the internal structure as seen from the front of the rack 300. The battery pack 200 is housed in a single housing and has, from top to bottom, a fan slot 301 having multiple cooling fans, a management slot 302 that accommodates the battery pack management device 202, and battery slots 303₁-303ₙ that houses the lithium-ion battery module 1. In addition, in order to dissipate heat from the lithium-ion battery module 1, a plurality of rectifying slots 304₁-304ₘ are provided.

FIG. 5B is a schematic diagram of the internal structure of the rack 300 as viewed from the side. The front of the rack comprises a battery pack management device 202 and a space, wherein the space becomes a cable duct 305 that connects the communication unit of the battery module management device 201 coupled to the lithium-ion battery module 1. A space that serves as an exhaust duct 306 is provided on the rear surface of the rack, wherein the exhaust duct 306 allows air drawn in from the front and bottom of the rack to come into contact with the lithium-ion battery module 1 so as to suck up the air by a cooling fan from the rear and top.

In terms of the plurality of lithium-ion battery modules 1, as shown in FIG. 3, the lead wire 57 serving as a cathode and the lead wire 59 serving as an anode, are led out from an exterior body 70. By using a connecting terminal that connects the cathode of a lithium-ion battery module to the anode of the upper lithium-ion battery module and a connecting terminal that connects the anode of a lithium-ion battery module to the cathode of the lower lithium-ion battery module, it is possible to connect a plurality of lithium-ion battery modules 1 in series. Herein, the connecting terminal is preferably a resin current collector made of the above-mentioned conductive polymer material.

### [Connection of Battery Modules]

The following is an example of a method for connecting the lithium-ion battery module 1 shown in FIG. 3 in a case when storing the lithium-ion battery module 1 as a battery pack 200 in the rack 300 shown in FIG. 5A and FIG. 5B.

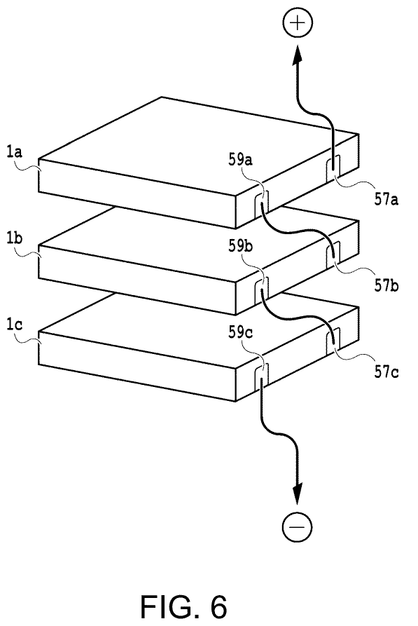

FIG. 6 shows a first example of a connection configuration of lithium-ion battery modules in a battery slot. In the rack 300, in terms of a pair of adjacent lithium-ion battery modules 1, a lead wire 59 that connects to the anode resin current collector 19 is connected to a lead wire 57 that connects to the cathode resin current collector. In the rack 300, 40 stages of the lithium-ion battery modules 1 are connected in series as the battery pack 200. The mutual connections of the lead wires are made as short as possible and the inductance component is reduced by using thick wiring materials, etc. This is to reduce the inductor component of the battery pack 200, similar to the case of the lithium-ion battery module 1 described above.

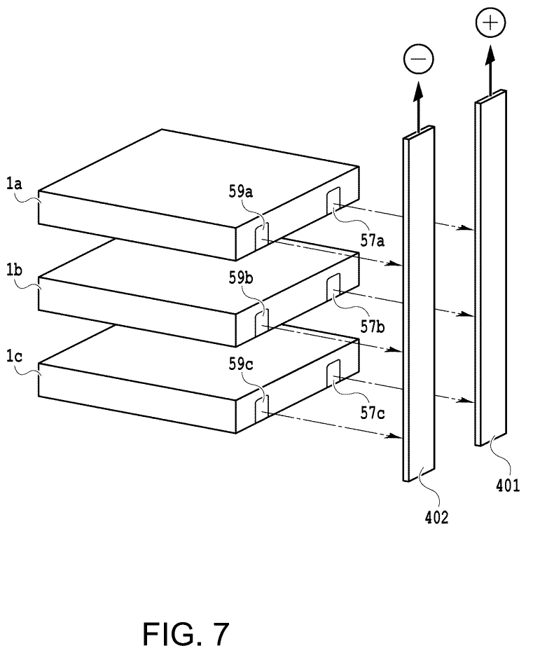

FIG. 7 shows a second example of a connection configuration of lithium-ion battery modules in a battery slot. When the lithium-ion battery modules 1 are connected in parallel in the rack 300, the connections are made using bus bars 401, 402. When the lithium-ion battery module 1 is housed in the rack 300, the lead wire 57 connected to the cathode resin current collector and the bus bar 401 that serves as the cathode of the battery pack are butt-connected. Similarly, the lead wire 59 connected to the anode resin current collector 19 and the bus bar 402 which serves as the anode of the battery pack are butt-connected. Compared with the wiring material described above, the inductor component of the battery pack 200 can be further reduced.

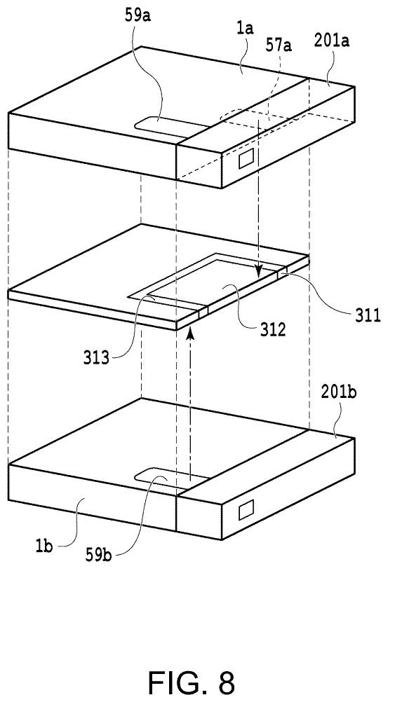

FIG. 8 shows a third example of a connection configuration of lithium-ion battery modules in a battery slot. This figure shows the structure of the shelf boards of the battery slot 303 that houses the lithium-ion battery module 1. The lithium-ion battery module 1 has a lead wire 59 extended from the upper surface and a lead wire 57 extended from the lower surface. The shelf board 311 is a metal plate. The shelf board 311 has a conductive electrode part 312 that is placed on the front of the rack, and that electrically connects the lead wire 57 on the underside of the upper lithium-ion battery module 1a and the lead wire 59 on the top side of the lower lithium-ion battery module 1b. The conductive electrode part 312 is formed on the main body of the shelf board 311 via an insulating part 313. Examples of materials forming the conductive electrode part 312 are such as copper, aluminum, titanium, stainless steel, nickel, and their alloys, as well as resin current collectors.

Since the lead wires 57 and 59 are connected in a planar manner via the conductive electrode part 312, the inductor component of the battery pack 200 can be further reduced compared to the wiring material shown in FIG. 6.

In this manner, the multiple lithium-ion battery modules 1 housed in the battery slots 303₁-303ₙ are connected in series. The lead wires 57, 59 and the conductive electrode part 312 have a given width so that the conductive resistance and inductance components are minimized.

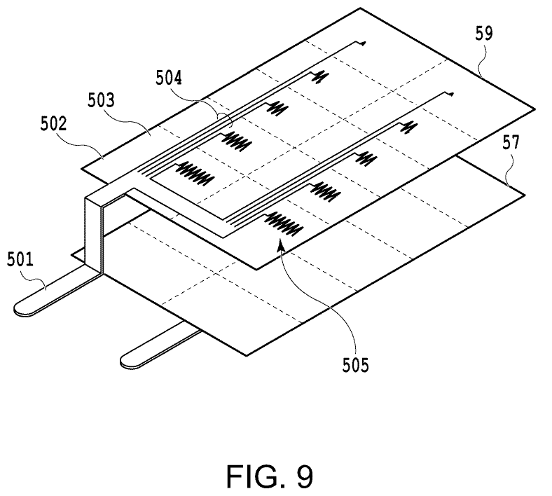

In terms of the lithium-ion battery module 1, the lead wire which is capable of reducing the influence of the inductor component will be explained. FIG. 9 shows the configuration of the lead wire of the lithium-ion battery module. The lead wire 59 comprises an outermost current collector 502 that connects to the anode current collector 19 on the uppermost surface of the assembled battery 50, and a tab 501 that extracts current from the outermost current collector 502 to the outside. The outermost current collector 502 is made of a flexible substrate and has a plurality of wirings 504 that are electrically connected to the tabs 501. The anode current collector 19 is virtually divided into a plurality of sections 503, and the wire 504 is composed of a plurality of wires that connect the tab 501 to each section.

In FIG. 9, it is divided into 10 sections. However, the number of sections 503 is arbitrary. For example, in the case of the cell 10 of 60 cm×100 cm, there can be 15 sections of 20 cm square. Further, although a flexible substrate is used as the outermost current collector in the above embodiment, a normal printed circuit board may be used, or a copper plate may be processed to form a wiring board.

The wiring 504 has a meandering wire part 505 in each section so as to set the distance between the connection point of the tab 501 and the anode current collector equal. The meandering wire part 505 is longer in a section closer to the tab 501 and shorter in a section farther from the tab 501. The lead wire 57 connected to the cathode current collector 17 on the bottom surface of the assembled battery 50 also has the same structure. With this configuration, the distance from the tab 501 of the lead wire 59 to the tab of the lead wire 57 through each section, is equal in each section. The meandering shape of the meandering wire part 505 is arbitrary, as long as it has a length necessary for adjusting the distance in each section 503. In term of the lead wire shown in FIG. 3, the resistance between the lead wires, which is close to the tab, led out from the exterior body 70 is low, and the resistance increases according to the distance from the tab. Therefore, the current is concentrated near the tab. As a result, not only will the cell unit 30 not be able to exhibit given input/output characteristics, but a different part of the cell unit 30 may face different degrees of deterioration over time. According to the configuration of the lead wire shown in FIG. 9, the resistance is equal in each section of the cell unit 30, so that current concentration does not occur.

In addition, by providing the meandering wire part 505, the capacitance as the assembled battery 50 is increased. With this increase, by canceling out the inductor component of the lithium-ion battery module 1 having the assembled battery 50, the influence of the inductor component can be reduced.

The battery pack according to this embodiment comprises a plurality of lithium-ion battery modules 1 that have the assembled battery 50 in which the anode current collector 19 and the cathode current collector 17 are directly connected. As described above, the inductor component of the lithium-ion battery module 1 alone is significantly lower than that of an assembled battery made of a combination of conventional cylindrical batteries. In addition, even when the lithium-ion battery modules 1 are connected in series, it has a structure that can suppress the conduction resistance and inductance components. Therefore, the inductor component of the battery pack can be significantly reduced compared to conventional methods.

### INDUSTRIAL APPLICABILITY

The battery module of this invention can be applied, for example, to a power source for electric vehicles, hybrid electric vehicles, etc., and as a power source for portable electronic devices.

1. A battery module comprising:
a cell that has a cathode resin current collector, a cathode active material layer, a separator, an anode active material layer, and an anode resin current collector,
wherein the cell comprises a frame member that seals the cathode active material layer, the separator, and the anode active material layer,
wherein the cathode resin current collector is placed on a first surface of the cell,
wherein the anode resin current collector is placed on a second surface of the cell,
a first assembled battery in which a predetermined number of adjacent pairs of the cells are stacked in series such that the first surface and the second surface of the adjacent pair of the cell are adjacent to each other, or a first assembled battery in which a predetermined number of cells, each of which has a cathode layer provided on one surface of a resin current collector and an anode layer provided on the other surface of the resin current collector, are stacked via an electrolyte layer;
in a case when the inductance of the cell is Ia,
the inductance of a wound-type cell consisting of a wound electrode group having a cathode plate that comprises a cathode metal current collector and a cathode mixture layer disposed on both sides of the cathode metal current collector, an anode plate that comprises an anode metal current collector and an anode mixture layer disposed on both sides of the anode metal current collector, and a separator that is disposed between the cathode plate and the anode plate, is Ib,
the inductance of the first assembled battery is Ic,
the inductance of a first wound-type cell module formed by connecting the predetermined number of the wound-type cells in series is Id,
wherein Ic/Ia<Id/Ib.

2. The battery module according to claim 1,
in a case when the inductance of a second assembled battery in which a plurality of the cells are stacked so as to correspond to the total energy amount of 0.5 to 3.3 kW is Ie, and
the inductance of a second wound-type cell module in which a plurality of the wound-type cells are connected in series so as to correspond to the total energy amount of 0.5 to 3.3 kW is If,
wherein Ie/If<0.11 is satisfied.

3. The battery module according to claim 1, further comprising:
an outermost current collector that locates on both ends of the first assembled battery; and
a tab that is connected to the outermost current collector for extracting current to the outside,
wherein the outermost current collector comprises a flexible substrate having wirings that are electrically connected to the tab, and
wherein the wiring comprises a meandering wire part that has a meandering shape.

4. The battery module according to claim 1, further comprising:
a connecting terminal that connects lead wires of adjacent battery modules;
wherein the connecting terminal comprises a first connecting terminal that connects a lead wire connected to a cathode current collector of a first battery module with a lead wire connected to an anode current collector of an adjacent second battery module, and a second connecting terminal that connects a lead wire connected to an anode current collector of the first battery module with a lead wire connected to a cathode current collector of an adjacent third battery module, and
wherein the connecting terminal is made of a resin current collector.

5. The battery module according to claim 4,
wherein the first connecting terminal and the second connecting terminal are conductive electrode parts that are formed on a part of a shelf board on which the battery module is placed.
